(19) United States
(12) Patent Application Publication
(10) Pub. No.: US 2007/0106960 A1
(43) Pub. Date: May 10, 2007

(54) System and method for the development and distribution of a VHDL intellectual property core

(75) Inventors: Yea Zong Kuo, Rockwall, TX (US); Jerry William Yancey, Greenville, TX (US)

Correspondence Address: LATHROP & GAGE LC, 4845 PEARL EAST CIRCLE, SUITE 300, BOULDER, CO, 80301, US

(73) Assignee: L-3 Integrated Systems Company

(21) Appl. No.: 11/270,179

(22) Filed: Nov. 9, 2005

(51) Int. Cl. G06F 17/50

(52) U.S. Cl. 716/1; 716/17

(57) ABSTRACT

Provided is a system and method for the development and distribution of a VHDL Intellectual Property (“IP”) Core. In particular, the system includes a module for regulating source control of core design files, a module for extracting or adding information to a file, and for controlling file release consistent with an IP Core Development Plan, and a module for ensuring the efficient integration of non-integral configuration design tools. A graphical user interface allows core designers to access and use system modules in an efficient and cost-effective manner. The reuse of IP core designs is facilitated by ensuring files are organized and controlled by file type, size, source control, etc., and by verifying that each file complies with the known or published IP Core Development Plan.

### FIELD OF THE INVENTION

This invention relates generally to software tools for IP core design and development. More particularly, this invention relates to a system and method for controlling the development and distribution of VHDL IP core design files and codes, according to the tenets of an IP Core Development Plan.

### BACKGROUND

The design and development of integrated circuits (“ICs”) e.g. field programmable gate arrays (“FPGA”) and application specific integrated circuits (“ASIC”), is a complex process requiring the generation and use of various types of files and source codes. In many, if not most, instances VHSIC (Very High Speed Integrated Circuits) Hardware Design Language (“VHDL”) is used as the design language of choice. VHDL can be used for the documentation, verification and synthesis of very large and complex digital designs, and is therefore an industry standard for IC development.

For a given VHDL design project, a variety of files may exist, including binary files or “binaries”, text files such as ACSII text files or other source code files, netlist files, object files, etc. A collection of these various files (data, executables, etc.), which define the design of FPGAs and/or ASICs, may constitute what is referred to in the art as an Intellectual Property (“IP”) core. IP cores are typically classified into three categories: hard cores, firm or semi-hard cores, and soft cores, depending on the portability of the core. Hard cores are the least portable, and are a physical manifestation of the IP core design. Hard cores are most often used in “plug and play” type applications. Firm or semi-hard cores are more flexible than hard cores. Although firm cores carry certain sets of placement data, they may be used in a variety of different applications. The most flexible type of core is the soft core, which may be nothing more than a netlist, i.e. a list of the logic gates and associated interconnections that comprise an integrated circuit. Intuitively, hard and firm cores typically contain a greater number of files than do soft cores.

There is a movement in the “integrated circuit” industry toward the reuse of IP core designs in an effort to increase the speed and efficiency with which FPGAs and ASICs are designed and manufactured. It goes without saying that increased speed and efficiency in the development of integrated circuits often leads to a corresponding reduction in production costs. Design reuse, however, requires a disciplined approach to organizing design files, as well as controlling the release or source control of files that define an IP core. Given the sheer number of files that are often involved in core design, the size of many files, as well as the various types of files that may be required, organization and source control is a difficult problem.

Depending on the files contained in an IP Core (which is indicative of the core type), differing levels of source control and file organization may be required or desired. In the early stages of IP Core design, the number of existing files may be limited. As such, control can be minimized, thereby giving designers the flexibility to be creative without being unduly constrained. On the other hand, hundreds or even thousands of files typically define a mature IP core design. Quite often, these files should be tightly controlled to ensure file integrity, and guarantee that a baseline of the IP core design is preserved.

The degree to which organization and source control should be implemented, as well as the more technical aspects of file development (formats, language, etc.), may be specified in an IP Core Development Plan which is typically vendor specific. The design of integrated circuits, as well as the manner in which design files/codes are organized and controlled, must comply with the guidelines set out in the IP Core Development Plan. This is especially true in those instances where IP core reuse is possible or preferred. An increased desire to reuse a given IP core, and the core design complexity itself, makes organization and control of design files/codes a daunting task. Existing source control tools are not designed to handle the number and variety of file types found in the IP core of a complex integrated circuit.

Hence, there is a need for a system for developing and distributing a VHDL IP core that adequately monitors and controls file organization, source control, and compliance with an IP Core Development Plan.

### SUMMARY

The system and method for the development and distribution of a VHDL intellectual property core disclosed herein advances the art and overcomes problems articulated above by providing a system and method that are both consistent with a IP Core Development Plan, and are relatively simple to implement and use.

In particular, and by way of example only, according to an embodiment, a method for developing, controlling and releasing VHSIC hardware design language (VHDL) project files constituting an intellectual property (“IP”) core is provided which includes: maintaining source control over the VHDL project files; ensuring adherence to one or more IP core development plans; and interacting with related core configuration tools.

In another embodiment, provided is a system for VHSIC hardware design language (VHDL) IP core development including: a means for maintaining source control over one or more VHDL project files; a means for ensuring adherence to one or more IP core development plans; and a means for interacting with related core configuration tools.

In yet another embodiment, a system for VHSIC hardware design language (VHDL) IP core development is provided, including: a source control module; a core release module; and an IP configuration module.

### BRIEF DESCRIPTION OF THE DRAWINGS

FIG. 1 is a schematic representation of a system for developing, controlling and distributing a VHDL IP core, according to an embodiment; and

FIG. 2 is a flowchart of a method for developing, controlling and distributing a VHDL IP core, according to an embodiment.

### DETAILED DESCRIPTION

Before proceeding with the detailed description, it should be noted that the present teaching is by way of example, not by limitation. The concepts herein are not limited to use or application with one specific type of system or method for developing and distributing one or more very high speed integrated circuit (“VHSIC”) hardware design language (“VHDL”) intellectual property (“IP”) core files. Thus, although the instrumentalities described herein are for the convenience of explanation, shown and described with respect to exemplary embodiments, the principles herein may be equally applied in other types of systems and methods for developing and distributing one or more VHDL IP cores or core files.

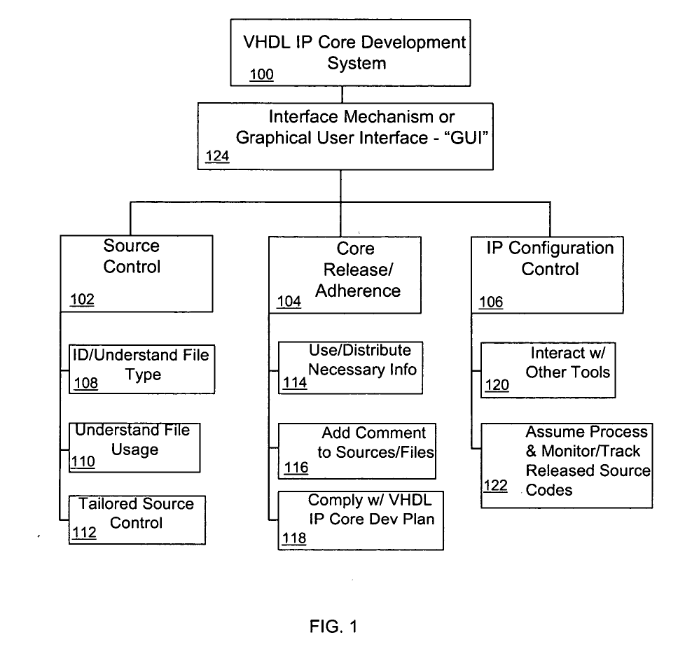

FIG. 1 is a schematic representation of one embodiment of a VHDL IP core development and distribution tool, system 100. System 100 comprises three separate yet interrelated functions or modules, e.g. a Source Control module 102, a Core Release module 104, and an IP Configuration Control module 106. The modules 102-106 synchronously operate to ensure efficient core design in compliance with a known or published IP Core Development Plan. More specifically, system 100 provides an IP core designer a structure to follow when developing the VHDL project files of the IP core. Further, system 100 organizes the IP core into a form that is efficiently controlled and released for future IP core use/re-use.

Considering Source Control module 102 in greater detail, several functions or functional controls are contained with this module 102. In particular, module 102 includes a function 108 which identifies each file applicable to a given IP core, and verifies the type of file, e.g. a “user constraint file” (“.ucf”) or a “vhdl source file” (“.vhd”) file. File type assessment and verification allows system 100 to define and understand the use(s) for a given file. File usage is yet another function 110 of module 102. By identifying and understanding the various files that comprise the IP core, system 100 can organize the IP core files into a form that promotes adequate source control, as well as efficient and selective release of files when requested by an IP core designer.

In addition to identifying the files of an IP core, and the corresponding use of the files for IP core design, Source Control module 102 includes a third function 112. Function 112 provides core designers the option to specify the degree to which files are source controlled at each step in the design process. For example, in the early design/development stages of an IP core, the core designer may not want to place significant restrictions or source control on a certain file. In an environment where changes are made quickly and often to a given design, limited source control may be preferred. Limited source control allows one or more designers to quickly access (“check-out”) a file, and modify the file for their particular use. Access and modification occurs without the need to comply with many of the more stringent and formal requirements of a fully-implemented source control program.

Alternatively, when a design is mature, for example a hard or firm IP core design, certain files should be controlled to ensure the integrity of the design data base. For example, when an IP core is being tested or used in a specific hardware configuration, source control of the files that define the core is recommended. In this instance it may be desirable to control, for example, pin location files, as well as other .ucf files related to a specific hardware design. Function 112 of module 102 allows for varying levels of source control, commensurate with the evolution of a specific IP core design.

Still referring to FIG. 1, the second module, Core Release module 104, includes several functions to properly control the release of an IP core consistent with a VHDL IP Core Development Plan. Information is collected (accessed/extracted) and generated in an effort to ensure the correct files are released for a given core design project, without releasing unnecessary or unrelated files, as well as proprietary or protected files the release of which is typically constrained. Specifically, one function 114 of module 104 accesses information contained in project files, and uses/distributes the information consistent with instructions contained in the VHDL IP Core Development Plan. Examples of information processed by function 114 would include resource utilization of the IP core, as well as the current version of a non-integral source code (e.g. PRISM).

In addition to gathering and distributing information pertaining to the IP core and related VHDL project files, module 104 provides a mechanism (i.e. modification function 116) for comments to be added to various source codes and files. Comments may include header information, as well as descriptive/explanatory comments required for efficient code implementation. The operations of function 116 compliment the operations of function 118, which verifies compliance/adherence with the coding guidelines and protocols of the VHDL IP Core Development Plan, allowing for selective release of files.

Acting in concert, the functions of modules 102 and 104 properly control the release of an IP core and its related files. For example, responding to a designer request to release the files associated with a specific IP core, system 100 can (using module 102) identify all of the files associated with the requested IP core. From those files identified and categorized, the binary files, or binaries, that define the elements of the core can be released without releasing the textual source code, the use of which may be unnecessary or unauthorized. Prior to release, and then again prior to a subsequent check-in of IP core files, module 104 may verify compliance with the VHDL IP Core Development Plan, as well as ensure that any necessary or desired header information, etc. is written to the files.

Considering now a third module 106 of system 100, the functions of this module 106 include: interaction with one or more non-integral tools used for configuring an IP core (function 120), thereby developing an application specific core configuration; and, monitoring/tracking released source codes and files generated using the non-integral tool (function 122). Often times, an IP core is configurable via a non-integral configuration tool, such as PRISM. In this context, a non-integral configuration tool is defined as a configuration tool or source code obtained from an outside source and integrated into an IP core by the core designer. The non-integral tool may be commercially available, or it may be a customized code specific to a given FPGA or ASIC design company. Function 118, within module 106, allows for interaction with the non-integral configuration tool, thereby ensuring code integration and compatibility during the design process.

Whether using integral or non-integral configuration design codes, an application specific configuration, in the form of source code and related files, can be defined by the IP core designer. Once the specific configuration is defined, function 122 monitors the release, source control and subsequent use of the application specific source code/files. It can be appreciated by those skilled in the art that the term “application specific” may refer to specificity at many levels in the design process, and may in fact refer to a source code or file that can be used in the design of many different FPGAs, ASICs, etc.

The successful implementation of the controls and structure provided by system 100 is facilitated, in part, by an interaction between the IP core designer and the system modules 102-106. For this purpose, system 100 includes an interface mechanism 124 which may be a graphical user interface or “GUI”. The interface mechanism 124 provides efficient access to system modules 102-106, as well as access to non-integral codes and related data files. The interface mechanism 124 may be coded in Visual Basic, or alternatively it may be coded in any one of several other object-oriented languages well known in the art. It can be appreciated that a GUI, as that term is known in the art, is but one means for inputting and receiving information related to IP core design. Other interface mechanisms well known in the art may also be used to interface with system 100 without departing from the scope and intent of the present disclosure.

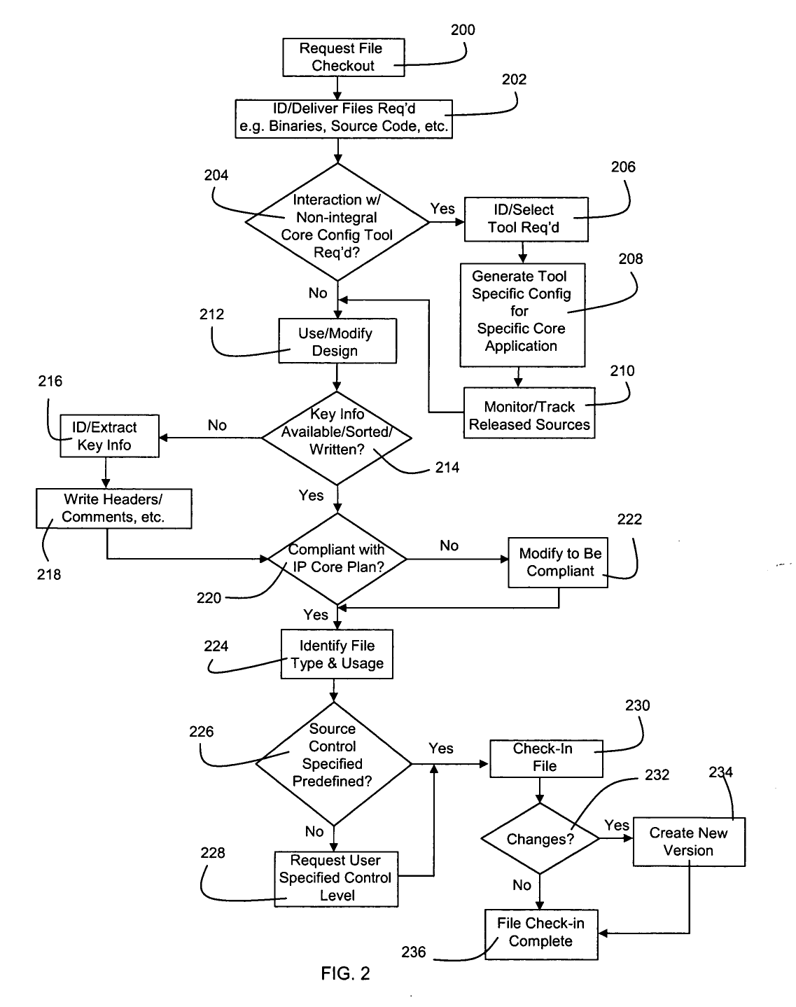

Considering now the operation of system 100, as part of an overall IP core design process, FIG. 2 outlines the functional relationship between system 100 modules 102-106. An important element of source control is the ability and requirement to check-in, and check-out, required design files. As one or more files for an IP core design are requested (block 200), system 100, and specifically module 102, identifies the files needed, e.g. binaries, source codes, data files, etc. (block 202). These files are delivered (block 202) through the GUI interface to the platform being used by the core designer to develop and/or modify the IP core design.

Concurrent with, or subsequent to, file retrieval, a core designer may identify one or more non-integral tools or codes required to configure the IP core, block 204. Through module 106, system 100 can identify and select the non-integral files (block 206), and make those files available for use in the core configuration process. The non-integral tools may be used to define an application specific configuration, starting with a known and possibly generic IP core design, block 208. Once an application specific configuration is generated, system 100 and specifically module 106, monitors the subsequent release and use of the file(s) associated with that configuration, block 210.

The core designer may use the existing IP core file(s) checked-out of a repository, or new files configured using a non-integral tool, to develop or modify the IP core design, block 212. After work on core design is complete, and the IP core files are finalized as to form, content, etc., system 100 may initiate a query regarding information required by the IP Core Development Plan, block 214. Required information may include the resource utilization of the IP core, the version of the non-integral source code being used, file data (size, format, etc.), as well as other information specified in the IP Core Development Plan. If the information required by the IP Core Development Plan is not already available/stored, the collection and processing of information (block 216) is controlled by module 104 of system 100. Additionally, if any information is written into the IP core files (block 218), this information is added substantially concurrent with the collection of information/data.

If new information is not generated/collected, or once the processing of new information is complete, system 100 assesses whether the IP core file or files are compliant with the IP Core Development Plan, block 220. Compliance may include format and labeling conventions, consistent use of language and terms within files or codes, etc. If a given file is not compliant, system 100, and in particular module 104, will direct the IP core designer, through the GUI, to modify the code to be compliant with the IP Core Development Plan, block 222. Once the file is compliant, system 100 will identify the file type and its use, as that use relates to the IP core, block 224.

As discussed above, system 100 provides the designer an opportunity to specify a level of source control for any given file or code. In this manner, files requiring strict and continuing control can be distinguished from files requiring little or no source control. As part of the file “check-in” process, module 102 can assess whether a level of source control has been specified, or whether a standard default control level is appropriate, block 226. If no level of source control has been specified or pre-defined, the system 100 will query the designer as to what level of control is desired/required, block 228.

Once the level of source control is ascertained by system 100, either through default settings or designer input, the file/code is ready to be checked back into the file repository, block 230. System 100 will assess whether changes have been made to a file/code since it was last “checked out”, block 232. If changes have been made, a new version of the file/code will be created by the system 100 (block 234), and the file/code will be saved, thereby completing file check-in process, block 236. If no changes have been made to the file/code, system 100 will simply check the file/code back into the repository (block 236) and make the current version of the file/code available to other designers.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall therebetween.

What is claimed is:

1. A method for developing, controlling and releasing VHSIC hardware design language (VHDL) project files constituting an intellectual property (“IP”) core, the method comprising:
maintaining source control over the VHDL project files;
ensuring adherence to one or more IP core development plans; and
interacting with related core configuration tools.

2. The method of claim 1, wherein maintaining source control further comprises:
identifying and recognizing one or more VHDL file types;
understanding file uses; and
tailoring file source control in accordance with file type and use.

3. The method of claim 2, wherein tailoring further comprises determining a source control need and applicable control level.

4. The method of claim 1, wherein ensuring adherence further comprises:
accessing from one or more VHDL project files information required under the one or more IP core development plans; and
modifying as necessary the one or more VHDL project files to be consistent with the one or more IP core development plans.

5. The method of claim 1, wherein interacting further comprises:
generating one or more application specific configurations using one or more non-integral core configuration tools; and
monitoring released files representative of the one or more application specific configurations.

6. The method of claim 1, further comprising a graphical user interface.

7. A system for VHSIC hardware design language (VHDL) intellectual property (“IP”) core development comprising:
a means for maintaining source control over one or more VHDL project files;
a means for ensuring adherence to one or more IP core development plans; and
a means for interacting with related core configuration tools.

8. The system of claim 7, wherein the means for maintaining source control is a source control module comprising:
a file assessment function;
a file usage function; and
a variable file source control function.

9. The system of claim 7, wherein the means for ensuring adherence further comprises:
an information access and extraction function;
a file modification function; and
a selective file release function.

10. The system of claim 7, wherein the means for interacting further comprises:
an integration function; and
a monitoring of released files function.

11. The system of claim 10, wherein the integration function further comprises:
a function for identifying and initializing a non-integral configuration tool; and
a function for using the non-integral configuration tool to generate an application specific IP core configuration.

12. The system of claim 7, further comprising means for interfacing with a user.

13. The system of claim 12, wherein the means for interfacing with a user is a graphical user interface.

14. The system of claim 13, wherein the operative language of the graphical user interface is an object-oriented language.

15. The system of claim 14, wherein the object-oriented language is Visual Basic.

16. A system for VHSIC hardware design language (VHDL) intellectual property (“IP”) core development comprising:
a source control module;
a core release and adherence module; and
an IP configuration control module.

17. The system of claim 16, wherein the source control module further comprises:
a function to identify a type of file being used;
a function for understanding file usage parameters; and
a function to provide a user an option to specify a level of source control.

18. The system of claim 17, wherein the level of source control may vary as a function of IP core development maturity.

19. The system of claim 16, further comprising a graphical user interface.

20. The system of claim 19, wherein the graphical user interface is coded in an object-oriented language.
